(19) United States
(12) Patent Application Publication
(10) Pub. No.: US 2025/0215742 A1
(43) Pub. Date: Jul. 3, 2025

(54) A MANUFACTURING METHOD OF AN INTELLIGENT ANTI-TERRORISM PROTECTIVE DOOR

(71) Applicant: Enyuan Liu, Yingkou, Liaoning (CN)

(72) Inventors: Lili Liu, Yingkou, Liaoning (CN); Enyuan Liu, Yingkou, Liaoning (CN)

(21) Appl. No.: 18/401,247

(22) Filed: Dec. 29, 2023

(51) Int. Cl. E06B 5/12; B05B 13/02; B21D 28/26; B23K 26/38; B65B 5/04; B65B 55/00; F41H 5/04; F41H 5/22

(52) U.S. Cl. CPC E06B 5/12; B05B 13/02; B21D 28/26; B23K 26/38; F41H 5/0442; F41H 5/226

(57) ABSTRACT

A manufacturing method of an intelligent anti-terrorism protective door comprises the following steps: S1, making front and rear door panels; S2, cutting the composite door core panel materials; S3, making protective door frame; S4, assembling bulletproof and explosion-proof armored composite door core panel; S5, making the door frame; S6, decorating the surface of the protective door; S7, overall assembly; S8, installing the lock; S9, packaging the protective door. The manufacturing method is simple and easy to implement, with strict control over every aspect from raw materials, production processes, to quality control during the manufacturing process, ensuring the product quality. This not only makes the product fire-proof and anti-theft, but also has explosion-proof and bulletproof properties, effectively preventing explosions and bullet attacks, greatly improving the security of the protective door.

### 1. TECHNICAL FIELD

The invention relates to the technical field of manufacturing protective doors, in particular to a manufacturing method of an intelligent anti-terrorism protective door.

### 2. BACKGROUND ART

With the continuous development of science and technology, people's awareness of safety and their living standards have been continuously improving. As a result, an increasing number of people are choosing to use protective doors as their main entrance security doors.

The full name of a protective door is “anti-theft security door”, which combines anti-theft and safety properties. At present, ordinary security doors on the market have a simple structure, use single materials, and are completed through welding and spraying, lacking the ability to prevent explosions or bullet impacts, thus having low security;

Even the current ordinary bulletproof doors only have individual bulletproof functions, and the bulletproof requirements are relatively low. Only the door body is bulletproof, not the entire door, moreover, they do not have explosion-proof or fire-proof functions. Many users now require a door that has bullet-proof, explosion-proof, fire-proof, and anti-theft functions. Currently, this type of ordinary protective door cannot meet the above requirements.

Therefore, a manufacturing method of an intelligent anti-terrorism protective door is proposed to solve the current shortcomings.

### 3. SUMMARY OF THE INVENTION

The technical problem to be solved by the invention is to overcome the defects of the above technology and provide a manufacturing method of an intelligent anti-terrorism protective door.

To realize the above technical problem, the technical scheme provided by the invention is as follow: a manufacturing method of an intelligent anti-terrorism protective door comprises the following steps:
S1, making front and rear door panels: the door panels are made of low-carbon steel plates with a thickness of 1.5 mm, they are cut according to the specified dimensions and then folded into shape by a bending machine, it is required that the end faces of the panels are smooth and any burrs are properly handled, they are then set aside for later use;
S2, cutting the composite door core panel materials: checking the materials and specifications of each layer of the composite door core panel, cutting the core panel materials into the specified dimensions with a laser cutting machine, and punching out the lock holes and installation process holes accordingly;
S3, making protective door frame: the material of the frame is made of low-carbon steel plate with a thickness of 3.5 mm, which is cut according to the specified dimensions, and then punched and welded to form the frame, the tolerance of the finished product is no more than 0.3 mm;
S4, assembling bulletproof and explosion-proof armored composite door core panel: coating the front and rear mating surfaces of each layer of the composite door core panel with two-component silicone adhesive, then assembling them in the frame in sequence, assembling the front and rear door panels on the front and back of the frame respectively, then placed in a pressing machine to be pressed into the specified dimensions, afterwards, left to dry naturally for 6 hours in a ventilated area, the production of the composite door core panel is completed;
S5, making the door frame: cutting the high-strength tough steel plate with a thickness of 2.5 mm into specified dimensions, and pulling it into shape through a frame material rolling machine, removing burrs, and welding it into shape, the tolerance of the finished product should not exceed 0.3 mm according to the design requirements;
S6, decorating the surface of the protective door: spray-painting the processed door frame, composite door core panel, and protective door front and rear panels, and hunging them on the curing oven production line for spray coating and curing;
S7, overall assembly: first, vertically placing the door frame on an assembly workbench, installing the composite door core panel into the door frame, installing hinges, adjusting the door gap, and checking whether the composite door core panel is parallel to the door frame;
S8, installing the lock: first, checking whether the lock hole and lock match stably, installing the lock into the lock hole, then installing the lock core into the lock, using an electric screwdriver to tighten the front and back screws, connecting the power supply, and performing switch debugging until it reaches a state of free switching.
S9, packaging the protective door: checking the door accessories and placing them inside a wooden packaging box along with the protective door, covering the door with bubble wrap to prevent the collision and damage, then, securing it with iron packaging tape, and the packaging is completed.

As an improvement, the composite door core panel materials comprise explosion-proof and bullet-proof materials, high-temperature resistant materials, explosion-proof and bullet-proof superimposed materials, impact-resistant buffer materials, anti-nuclear radiation materials, thermal insulation and fireproof materials.

As an improvement, in S6, the drying oven temperature of the curing oven production line must not be lower than 200° C., and the curing time is 20 min.

As an improvement, in S7, the upper side gap and the left and right side gaps between the composite door core panel and the door frame are not larger than 2.5 mm, and the lower side gap is not larger than 5 mm.

As an improvement, the door accessories comprise screws for fixed installation, a remote control, and a manual opening key.

Compared with the prior art, the invention has the following advantages:
1. The armored composite door core panel is formed by combining a variety of materials, and combined with its door frame, panels, etc. to form its complete structure, the invention has the fireproof and anti-theft functions, and also increases its anti-explosion, bulletproof and radiation-proof functions to achieve multi-performance integration and improve its security;
2. Through the implementation of processes such as front and rear door panels, composite door core panel, protective door frame, assembly, and lock installation, the overall manufacture of the protective door is achieved, ensuring the integrity, practicality, and aesthetics of its structure, and achieving its design goals, at the same time, the intelligent lock enhances the intelligence of the protective door, achieving the integration of multiple protection and intelligent function, greatly improving the security of the protective door;
3. The manufacturing method is simple and easy to implement, with strict control over every aspect from raw materials, production processes, to quality control during the manufacturing process, ensuring the product quality, this not only makes the product fire-proof and anti-theft, but also has explosion-proof and bulletproof properties, effectively preventing explosions and bullet attacks, greatly improving the security of the protective door.

### 4. SPECIFIC EMBODIMENT OF THE INVENTION

In order to make the objects, technical schemes and advantages of the embodiments of the invention clearer, the technical schemes in the embodiments of the invention will be clearly and completely described below in combination with the accompanying drawings in the embodiments of the invention, obviously, the described embodiments are some, but not all embodiments of the invention. The components of the embodiments of the invention generally described and illustrated in the drawings herein may be arranged and designed in a variety of different configurations.

In the description of the invention, it should be understood that the orientation or positional relationship indicated by the terms “center”, “upper”, “lower”, “left”, “right”, “vertical”, “horizontal”, “inner”, “outer” and so on are based on the orientation or positional relationship shown in the accompanying drawings, or the orientation or positional relationship that product of the invention is usually placed in when it is used, only for the convenience of describing the invention and simplifying the description, rather than indicating or implying that the indicated device or element must have a specific orientation, as well as a specific orientation structure and operation, therefore, it should not be construed as a limitation of the invention. In addition, the terms of “first”, “second”, “third” and so on are only used to differentiate the description, and should not be construed as indicating or implying relative importance.

In addition, if the terms “horizontal”, “vertical”, “overhanging” and other terms appear, it does not mean that the component is required to be absolutely horizontal or overhanging, but can be slightly inclined. For example, “horizontal” simply means that its direction is more horizontal than “vertical”, it does not mean that the structure must be completely horizontal, but can be slightly inclined.

In the description of the invention, “a plurality of” means at least two.

In the description of the invention, it should also be noted that the terms of “arrange”, “install”, “link”, “connect”, etc., should be generally understood unless there are specific restrictions or stipulations, for example, the “connect” may refer to fixed connection, detachable connection or integral connection; the “connect” may also refer to mechanical connection or electrical connection; the means of “connect” may be directly connected or indirectly connected through an intermediate medium, and may be internal communication between the two elements. For those skilled in the art, the specific meaning of the above terms in the invention can be understood according to the specific situation.

A manufacturing method of an intelligent anti-terrorism protective door comprises the following steps:
S1, making front and rear door panels: the door panels are made of low-carbon steel plates with a thickness of 1.5 mm, they are cut according to the specified dimensions and then folded into shape by a bending machine, it is required that the end faces of the panels are smooth and any burrs are properly handled, they are then set aside for later use;
S2, cutting the composite door core panel materials: checking the materials and specifications of each layer of the composite door core panel, cutting the core panel materials into the specified dimensions with a laser cutting machine, and punching out the lock holes and installation process holes accordingly;

Specifically, the material and combination settings of the composite door core panel materials can be set according to the actual situation. In this embodiment, the composite door core panel materials comprise explosion-proof and bullet-proof materials, high-temperature resistant materials, explosion-proof and bullet-proof superimposed materials, impact-resistant buffer materials, anti-nuclear radiation materials, thermal insulation and fireproof materials.

S3, making protective door frame: the material of the frame is made of low-carbon steel plate with a thickness of 3.5 mm, which is cut according to the specified dimensions, and then punched and welded to form the frame, the tolerance of the finished product is no more than 0.3 mm;

S4, assembling bulletproof and explosion-proof armored composite door core panel: coating the front and rear mating surfaces of each layer of the composite door core panel with two-component silicone adhesive, then assembling them in the frame in sequence, assembling the front and rear door panels on the front and back of the frame respectively, then placed in a pressing machine to be pressed into the specified dimensions, afterwards, left to dry naturally for 6 hours in a ventilated area, the production of the composite door core panel is completed;

During the specific implementation, the explosion-proof and bullet-proof materials, high-temperature resistant materials, explosion-proof and bullet-proof superimposed materials, impact-resistant buffer materials, anti-nuclear radiation materials, thermal insulation and fireproof materials are arranged in order, and the mating surfaces are applied with two-component silicone adhesive, and assemblied.

S5, making the door frame: cutting the high-strength tough steel plate with a thickness of 2.5 mm into specified dimensions, and pulling it into shape through a frame material rolling machine, removing burrs, and welding it into shape, the tolerance of the finished product should not exceed 0.3 mm according to the design requirements;

S6, decorating the surface of the protective door: spray-painting the processed door frame, composite door core panel, and protective door front and rear panels, and hunging them on the curing oven production line for spray coating and curing;

Specifically, the drying oven temperature of the curing oven production line must not be lower than 200° C., and the curing time is 20 min.

S7, overall assembly: first, vertically placing the door frame on an assembly workbench, installing the composite door core panel into the door frame, installing hinges, adjusting the door gap, and checking whether the composite door core panel is parallel to the door frame;

During the specific implementation, the upper side gap and the left and right side gaps between the composite door core panel and the door frame are not larger than 2.5 mm, and the lower side gap is not larger than 5 mm.

S8, installing the lock: first, checking whether the lock hole and lock match stably, installing the lock into the lock hole, then installing the lock core into the lock, using an electric screwdriver to tighten the front and back screws, connecting the power supply, and performing switch debugging until it reaches a state of free switching.

S9, packaging the protective door: checking the door accessories and placing them inside a wooden packaging box along with the protective door, covering the door with bubble wrap to prevent the collision and damage, then, securing it with iron packaging tape, and the packaging is completed.

Specifically, the door accessories comprise screws for fixed installation, a remote control, and a manual opening key.

The invention and its embodiments are described above, this description is not restrictive, and what is shown in the accompanying drawing is only one of the embodiments of the invention, and the actual structure is not limited to this. All in all, if those skilled in the art receives its enlightenment, without deviating from the object of the invention, and without creatively designing structures and embodiments similar to the technical scheme of the invention shall fall within the protection scope of the invention.

1. A manufacturing method of an intelligent anti-terrorism protective door comprises the following steps:
S1, making front and rear door panels: the door panels are made of low-carbon steel plates with a thickness of 1.5 mm, they are cut according to the specified dimensions and then folded into shape by a bending machine, it is required that the end faces of the panels are smooth and any burrs are properly handled, they are then set aside for later use;
S2, cutting the composite door core panel materials: checking the materials and specifications of each layer of the composite door core panel, cutting the core panel materials into the specified dimensions with a laser cutting machine, and punching out the lock holes and installation process holes accordingly;
S3, making protective door frame: the material of the frame is made of low-carbon steel plate with a thickness of 3.5 mm, which is cut according to the specified dimensions, and then punched and welded to form the frame, the tolerance of the finished product is no more than 0.3 mm;
S4, assembling bulletproof and explosion-proof armored composite door core panel: coating the front and rear mating surfaces of each layer of the composite door core panel with two-component silicone adhesive, then assembling them in the frame in sequence, assembling the front and rear door panels on the front and back of the frame respectively, then placed in a pressing machine to be pressed into the specified dimensions, afterwards, left to dry naturally for 6 hours in a ventilated area, the production of the composite door core panel is completed;
S5, making the door frame: cutting the high-strength tough steel plate with a thickness of 2.5 mm into specified dimensions, and pulling it into shape through a frame material rolling machine, removing burrs, and welding it into shape, the tolerance of the finished product should not exceed 0.3 mm according to the design requirements;
S6, decorating the surface of the protective door: spray-painting the processed door frame, composite door core panel, and protective door front and rear panels, and hunging them on the curing oven production line for spray coating and curing;
S7, overall assembly: first, vertically placing the door frame on an assembly workbench, installing the composite door core panel into the door frame, installing hinges, adjusting the door gap, and checking whether the composite door core panel is parallel to the door frame;
S8, installing the lock: first, checking whether the lock hole and lock match stably, installing the lock into the lock hole, then installing the lock core into the lock, using an electric screwdriver to tighten the front and back screws, connecting the power supply, and performing switch debugging until it reaches a state of free switching.
S9, packaging the protective door: checking the door accessories and placing them inside a wooden packaging box along with the protective door, covering the door with bubble wrap to prevent the collision and damage, then, securing it with iron packaging tape, and the packaging is completed.

2. A manufacturing method of an intelligent anti-terrorism protective door of claim 1, the composite door core panel materials comprise explosion-proof and bullet-proof materials, high-temperature resistant materials, explosion-proof and bullet-proof superimposed materials, impact-resistant buffer materials, anti-nuclear radiation materials, thermal insulation and fireproof materials.

3. A manufacturing method of an intelligent anti-terrorism protective door of claim 1, in S6, the drying oven temperature of the curing oven production line must not be lower than 200° C., and the curing time is 20 min.

4. A manufacturing method of an intelligent anti-terrorism protective door of claim 1, in S7, the upper side gap and the left and right side gaps between the composite door core panel and the door frame are not larger than 2.5 mm, and the lower side gap is not larger than 5 mm.

5. A manufacturing method of an intelligent anti-terrorism protective door of claim 1, the door accessories comprise screws for fixed installation, a remote control, and a manual opening key.
